(19) United States
(12) Patent Application Publication
(10) Pub. No.: US 2004/0074124 A1
(43) Pub. Date: Apr. 22, 2004

(54) Miniature sports logo display

(76) Inventor: Roman Andrys, Lake Orion, MI (US)

Correspondence Address: Gregory T. Zalecki, Suite 415, 12900 Hall Rd., Sterling Heights, MI, 48313, US

(21) Appl. No.: 10/272,791

(22) Filed: Oct. 17, 2002

(51) Int. Cl. G09F 7/22; G09F 21/04; G09F 7/00

(52) U.S. Cl. 40/617; 40/597; 40/593

(57) ABSTRACT

A miniature sports logo display is disclosed. It allows a miniature sports team uniform, together with the team logo, the team color, a player's name and a player's number to be publicly displayed from a motor vehicle window. The invention is comprised of a miniature sports uniform having the described features and adapted to receive a miniature hanger, a miniature hanger inserted into the uniform for suspension of the uniform, and means, such as a suction cup, for securing the miniature hanger and uniform to a substantially vertical surface, attached to the hook of the miniature hanger. Optionally, the miniature sports uniform may be covered with a transparent cover.

### BACKGROUND

Sports memorabilia and souvenirs are very popular and very marketable. Numerous professional, college, high school, recreational league and other sports teams exist. These teams have numerous fans and supporters. The fans and supporters often desire to demonstrate their team loyalty.

The sporting world comprises many different sports. The sports include hockey, football, soccer, basketball, baseball and automobile racing. The common thread to all such organized sports is that the participants wear uniforms while engaged in the sporting event. Typically, these uniforms have a unique shape, display a team logo, display a team color, display a player's name and display a player's number. Some or all of such sports uniform features are incorporated into sports souvenirs and memorabilia.

There exists a large souvenir and memorabilia customer base desiring to demonstrate sports team loyalty by displaying items containing some or all of said sports uniform features. There is always a demand for items displaying team logos, team colors, player names and player numbers. There is a need for a miniature sports logo display shaped as a miniature sports uniform which is capable of incorporating team logos, team colors, player names and player numbers and which is also capable of being displayed by attaching it to a vehicle window, building window, office wall, residential wall, refrigerator, bulletin board, or the like.

### SUMMARY

The present invention satisfies this need. The invention is a miniature sports logo display comprising a uniform, a miniature hanger and means for securing the miniature hanger and uniform to a substantially vertical surface. The miniature sports logo display is intended to permit its owner to hang it on a vertical surface, such as an automobile window, to display and demonstrate the owner's loyalty to a selected sports team or player.

The uniform is sized and shaped as a miniature sports uniform. It is adapted to receive a displayable sports team logo, a sports team color, a player name and a player number. It is further adapted to receive a miniature hanger for suspending the uniform. In an alternate embodiment of this invention, the uniform has a sports team logo, a sports team color, a player name and a player number.

The miniature hanger has a hook and a suspension member. The suspension member is inserted into the inner upper periphery of the uniform. This allows the uniform to be suspended by the hanger when the hanger is affixed to a substantially vertical surface.

Means for securing the miniature hanger and uniform to a substantially vertical surface are attached to the hook of the miniature hanger. Preferably, said means comprises a suction cup. Said means may also comprise a magnet. Other means for securing the miniature hanger and uniform to a substantially vertical surface include fastening devices attached to the miniature hanger such as Velcro, a nail, a screw, tape, glue and string.

A transparent cover having an opening on its upper edge for allowing the hook of the miniature hanger, but not the suspension member the miniature hanger, to pass through it may optionally be draped over the uniform and miniature hanger such that the hook of the miniature hanger protrudes through the cover opening. The transparent cover protects the uniform, while allowing it to be displayed.

### DRAWINGS

These and other features, aspects, and advantages of the present invention will become better understood with regard to the following description, appended claims, and accompanying drawings where:

FIG. 1 is a front elevation view of a miniature sports logo display, including a transparent cover.

FIG. 2 is a front elevation view of the miniature sports logo display of FIG. 1, without the transparent cover, and further showing an alternate means for securing the miniature sports logo display to a substantially vertical surface.

FIG. 3 is an exploded front elevation view of the miniature sports logo display of FIG. 1 showing the hanger separated from the miniature sports uniform.

FIG. 4 is a rear elevation view of the miniature sports logo display of FIG. 2.

### DESCRIPTION

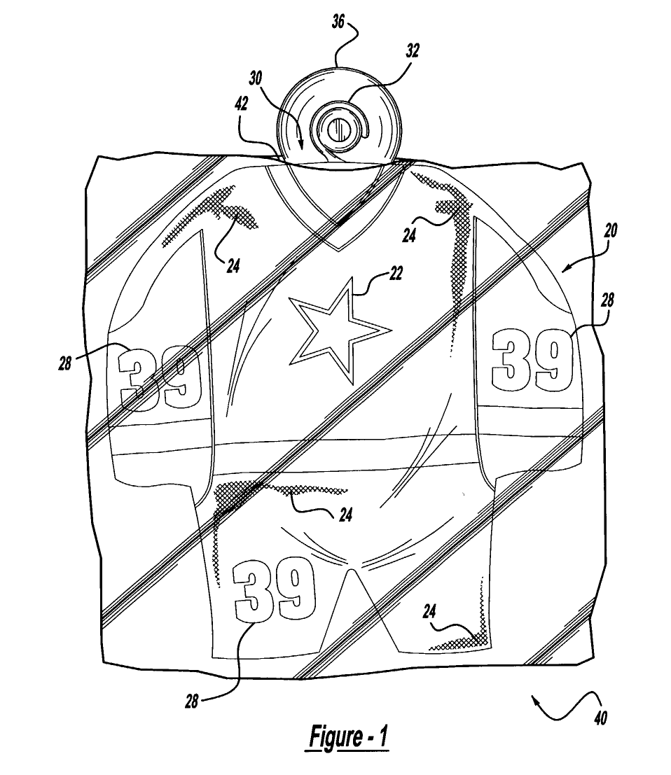

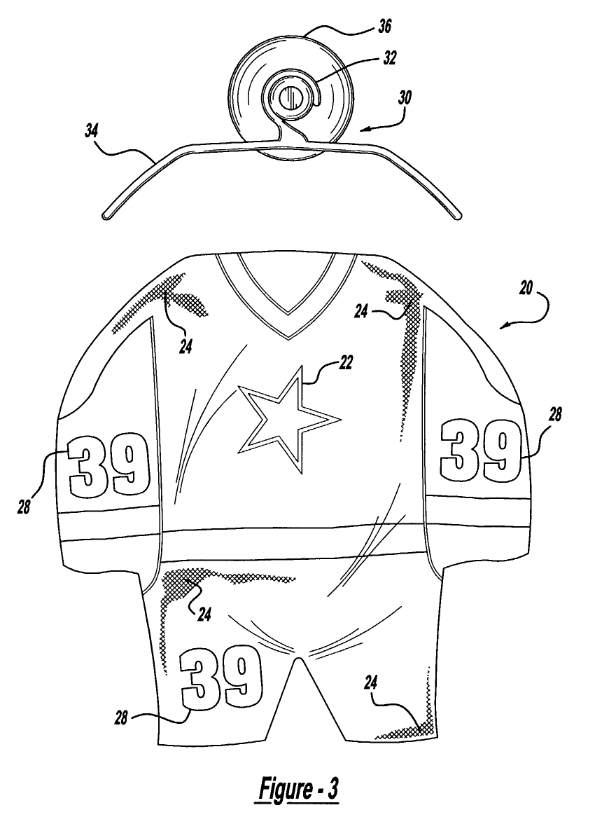

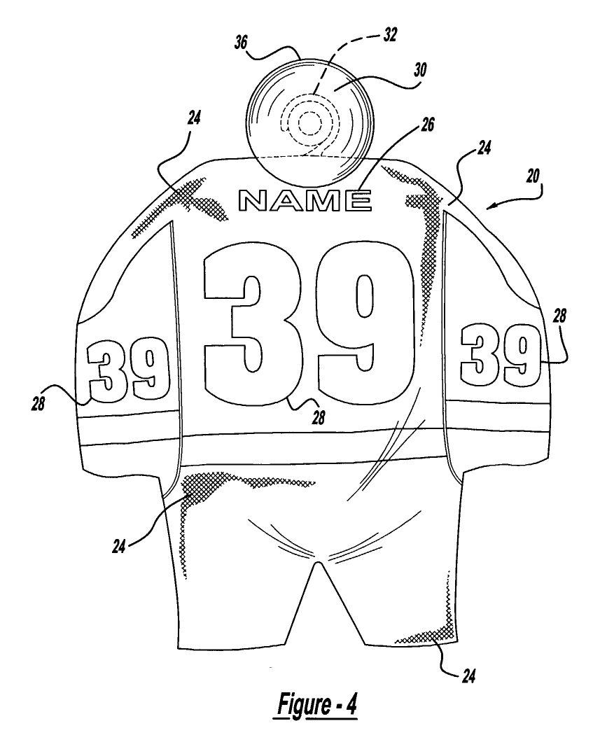

A preferred version of the invention is illustrated in FIG. 1 through FIG. 4. A miniature sports uniform 20 is fabricated from cloth. Many sports uniforms consist of an upper jersey and a lower pair of pants. The terms sports uniform as used herein includes both a combination jersey and pants and a jersey alone. Although most sports uniforms are sized to fit adults or children, the preferred size of the miniature sports uniform 20 is approximately six inches in length and five inches in width. The preferred size is obtained by proportional scaling of a full-size sports uniform to the size of a miniature sports uniform 20.

A sports team and player are selected for emulation. Most sports teams have a team logo 22 and a team color 24. Typically, the team logo 22 is a graphic design and the team color 24 consists of a colored pattern placed upon the sports uniform. Many sports teams place the name 26 of a player on the back of the uniform and place the player's respective number 28 at various locations upon the uniform.

FIG. 1 through FIG. 4 show a miniature hockey uniform 20. The uniform includes a jersey and a pair of pants. This invention is not limited to miniature hockey uniforms. Any sports uniform may be miniaturized. The miniature sports uniform 20 may be a hockey, football, soccer, basketball, baseball, automobile racing or any other sports uniform. The miniature sports uniform 20 may consist of only a jersey, or it may consist of a combination jersey and pair of pants.

Preferably, the miniature sports uniform 20 contains the team logo 22, the team color 24, the player name 26 and the player number 28 which were selected for emulation. In an alternate embodiment of this invention, the miniature sports uniform 20 does not contain a team logo 22, a team color 24, a player name 26 or a player number 28, but is adapted to receive a displayable sports team logo 22, a sports team color 24, a player name 26 and a player number 28.

The miniature sports uniform 20 is adapted to receive a miniature hanger 30 for suspension of the miniature sports uniform 20. Preferably, the miniature hanger 30 is constructed from plastic.

The miniature hanger 30 has a hook 32 and a suspension member 34. The suspension member 34 of the hanger 30 is inserted into the inner upper periphery of the miniature sports uniform 20, for suspension of the miniature sports uniform 20.

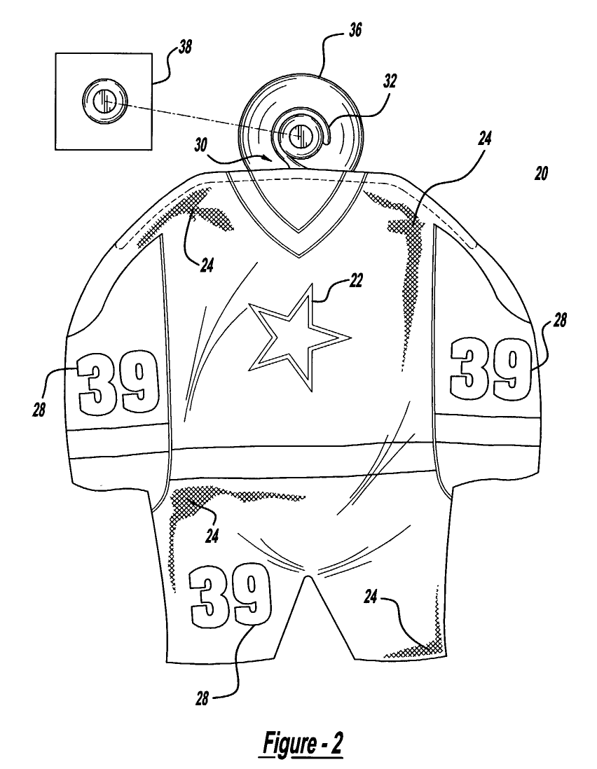

Means 38 for securing the miniature hanger 30 and the miniature sports uniform 20 to a substantially vertical surface are attached to the hook 32 of the miniature hanger 30. Preferably, said means 38 comprises a suction cup 38. Said means 38 may also comprise a magnet 38, as shown in FIG. 2. Other means 38 for securing the miniature hanger 30 and uniform 20 to a substantially vertical surface include fastening devices attached to the miniature hanger such as Velcro, a nail, a screw, tape, glue and string.

Preferably, a transparent cover 40 having an opening 42 on its upper edge for allowing the hook 32 of the miniature hanger 30, but not the suspension member 34 of the miniature hanger 30, to pass through said opening 42 is draped over the miniature sports uniform 20 and miniature hanger 30, such that the hook 32 of the miniature hanger 30 protrudes through the cover opening 42, for protecting and displaying the uniform 20, as shown in FIG. 1. Preferably, the transparent cover 40 is fabricated from cellophane. Any light weight flexible transparent material may be used.

The miniature sports logo display is used by attaching it to a substantially vertical surface. Ideally, it is used in a motor vehicle. The suction cup 38 is moistened and pressed onto one of the vehicle windows. This causes the miniature sports uniform 20 having the team logo 22, the team color 24, the player name 26 and the player number 28 to be displayed to the public, thereby showing the user's loyalty to the emulated team and player.

What is claimed is:

1. A miniature sports logo display comprising:
(a) a uniform sized and shaped as a miniature sports uniform, adapted to receive a displayable sports team logo, a sports team color, a player name and a player number, the uniform being further adapted to receive a miniature hanger for suspending the uniform;
(b) a miniature hanger having a hook and a suspension member, the suspension member being inserted into the inner upper periphery of the uniform, for suspension of the uniform; and
(c) means for securing the miniature hanger and uniform to a substantially vertical surface attached to the hook of the miniature hanger.

2. A miniature sports logo display comprising:
(a) a uniform sized and shaped as a miniature sports uniform, adapted to receive a displayable sports team logo, a sports team color, a player name and a player number, the uniform being further adapted to receive a miniature hanger for suspending the uniform;
(b) a miniature hanger having a hook and a suspension member, the suspension member being inserted into the inner upper periphery of the uniform, for suspension of the uniform;
(c) means for securing the miniature hanger and uniform to a substantially vertical surface attached to the hook of the miniature hanger; and
(d) a transparent cover having an opening on its upper edge for allowing the hook of the miniature hanger, but not the suspension member of the miniature hanger, to pass through said opening, draped over the uniform and miniature hanger such that the hook of the miniature hanger protrudes through the cover opening, for protecting and displaying the uniform.

3. The miniature sports logo display of claim 1, wherein the means for securing the miniature hanger and uniform to a substantially vertical surface comprises a suction cup.

4. The miniature sports logo display of claim 1, wherein the means for securing the miniature hanger and uniform to a substantially vertical surface comprises a magnet.

5. The miniature sports logo display of claim 2, wherein the means for securing the miniature hanger and uniform to a substantially vertical surface comprises a suction cup.

6. The miniature sports logo display of claim 2, wherein the means for securing the miniature hanger and uniform to a substantially vertical surface comprises a magnet.

7. A miniature sports logo display comprising:
(a) a uniform sized and shaped as a miniature sports uniform, having a displayable sports team logo, a sports team color, a player name and a player number, the uniform being further adapted to receive a miniature hanger for suspending the uniform;
(b) a miniature hanger having a hook and a suspension member, the suspension member being inserted into the inner upper periphery of the uniform, for suspension of the uniform; and
(c) means for securing the miniature hanger and uniform to a substantially vertical surface attached to the hook of the miniature hanger.

8. The miniature sports logo display of claim 7, further comprising a transparent cover having an opening on its upper edge for allowing the hook of the miniature hanger, but not the suspension member of the miniature hanger, to pass through said opening, draped over the uniform and miniature hanger such that the hook of the miniature hanger protrudes through the cover opening, for protecting and displaying the uniform.

9. The miniature sports logo display of claim 7, wherein the means for securing the miniature hanger and uniform to a substantially vertical surface comprises a suction cup.

10. The miniature sports logo display of claim 7, wherein the means for securing the miniature hanger and uniform to a substantially vertical surface comprises a magnet.

11. The miniature sports logo display of claim 8, wherein the means for securing the miniature hanger and uniform to a substantially vertical surface comprises a suction cup.

12. The miniature sports logo display of claim 8, wherein the means for securing the miniature hanger and uniform to a substantially vertical surface comprises a magnet.
